(19) United States
(12) Patent Application Publication
(10) Pub. No.: US 2026/0112561 A1
(43) Pub. Date: Apr. 23, 2026

(54) ALARM SWITCHING CRADLE FOR CIRCUIT BREAKER

(71) Applicant: EATON INTELLIGENT POWER LIMITED, DUBLIN 4 (IE)

(72) Inventors: Missael Enrique Coste Nunez, Santo Domingo (DO); Glennys Johanny De Jesus Reyes, McDonald, PA (US); Luis Enrique Betances Sansur, Santo Domingo (DO); Luis Jose Ynfante Peña, Santiago (DO); Ramon Alexander Perez Suarez, Santo Domingo (DO)

(73) Assignee: EATON INTELLIGENT POWER LIMITED, DUBLIN 4 (IE)

(21) Appl. No.: 18/922,687

(22) Filed: Oct. 22, 2024

(51) Int. Cl. H01H 71/02; H01H 71/04

(52) U.S. Cl. CPC H01H 71/025; H01H 71/04

(57) ABSTRACT

An improved cradle for a circuit breaker is structured to latch and unlatch the operating mechanism and to directly actuate a trip alarm. A support structure partitions the interior of the circuit breaker housing into a mechanism side and a PCB side. The cradle includes a main body and a cradle arm. The operating mechanism and main body are on the mechanism side, and a PCB and trip alarm are positioned on the PCB side. The cradle arm extends from the mechanism side through an opening formed in the support structure to the PCB side. When the circuit breaker is in the ON state, the cradle latches the operating mechanism. When the PCB detects a fault condition, the PCB initiates action that rotates the cradle, causing the cradle to unlatch the operating mechanism and causing the cradle arm to actuate the trip alarm.

### FIELD OF THE INVENTION

The disclosed concept relates generally to circuit breakers, and in particular, to devices and systems for alerting personnel to the occurrence of tripping in circuit breakers.

### BACKGROUND OF THE INVENTION

Circuit interrupters, such as for example and without limitation, circuit breakers, are typically used to protect electrical circuitry from damage due to an overcurrent condition, such as an overload condition or a short circuit, or another fault condition, such as a ground fault. Circuit interrupters typically include mechanically operated separable electrical contacts, which operate as a switch. When the separable contacts are in contact with one another in a closed state, current can flow through any circuits connected to the circuit interrupter. When the separable contacts are separated from one another in an open state, current is prevented from flowing through any circuits connected to the circuit interrupter. The separable contacts may be operated either manually by way of an operator handle, remotely by way of an electrical signal, or automatically in response to a detected fault condition. Typically, such circuit interrupters include an actuator designed to rapidly close or open the separable contacts, and a trip mechanism, such as a trip unit, which senses a number of fault conditions to trip the separable contacts open automatically using the actuator. Upon sensing a fault condition, the trip unit trips the actuator to move the separable contacts to their open position.

A miniature circuit breaker (MCB) is a particular type of circuit breaker that is compact in size and used to protect circuits from overloads and short circuits. MCBs automatically trip or switch off when they detect abnormal electrical conditions, preventing damage to equipment and reducing the risk of electrical fires. The compact form factor, efficiency, and reliability of MCBs makes them suitable for use in residential, commercial, and industrial settings.

In at least one known MCB, the interior of which is shown in FIGS. 1A-1B, a cradle is used to latch and unlatch the operating mechanism and is additionally used to trigger an alarm whenever a trip occurs. FIG. 1A is a photo of a first portion of the interior of an MCB 1, and FIG. 1B is a photo of a second portion of the interior of the MCB 1. More specifically, FIG. 1A shows a first portion of an actuating arrangement 3 positioned on a first side of a support structure 5 that is disposed within and fixedly coupled to the housing of the MCB 1, and FIG. 1B shows a second portion of the actuating arrangement 3 positioned on a second side of the support structure 5. The first side of the support structure 5 shown in FIG. 1A can be referred to as the mechanism side, as many of the mechanical components of the operating mechanism that actuate opening and closing of the separable contacts (not visible in the figures) are positioned on this side. The second side of the support structure 5 shown in FIG. 1B can be referred to as the PCB side, as a printed circuit board (PCB) 7 is visible on this side. The PCB 7 is configured to monitor the electrical conditions and initiate tripping of the separable contacts via other electrical and mechanical components in the actuating arrangement 3. The MCB 1 is depicted in a tripped state in FIGS. 1A-1B wherein the separable contacts are open/separated and current cannot flow through the MCB 1. The actuating arrangement 3 is designed to ensure that an alarm is triggered when a trip is actuated, so that personnel can be alerted to the occurrence of the trip.

As shown in FIG. 1B, the MCB 1 includes an alarm switch 11 with a button 12 that can be actuated in order to trigger an alarm. The MCB 1 also includes a lever 13 positioned to actuate the alarm button 12, with the lever 13 being rotatably coupled to the support structure 5 by a fastener and washer arrangement 15. As shown in FIG. 1A, the lever 13 comprises a tab 17 which extends through an opening 18 in the support structure 5 to the mechanism side of the MCB 1. The mechanism side includes a cradle 19 (FIG. 1A) that is coupled to the housing and is used to latch and unlatch the operating mechanism. That is, the cradle 19 engages the operating mechanism in order to keep the separable contacts closed when electrical conditions within the MCB 1 are within the rating of the MCB 1, and when a fault condition is detected by the PCB 5, the PCB 5 initiates action to rotate the cradle 19 such that the cradle 19 disengages from the operating mechanism and causes the operating mechanism to open the separable contacts.

As shown in FIG. 1A, the actuating arrangement 3 is designed so that, when the separable contacts of the MCB 1 are closed, a portion of the cradle 19 is positioned adjacent to the lever tab 17. When the PCB 7 detects a fault condition and initiates a trip, the cradle 19 is caused to rotate counterclockwise (relative to the view shown in FIG. 1A) in order to engage the tab 17 (i.e. by pushing against the tab 17) so as to rotate the entire lever 13 relative to the fastener and washer arrangement 15 on the PCB side. Relative to the view shown in FIG. 1B, when the lever 13 is rotated sufficiently in the counterclockwise direction, the lever 13 pushes against the alarm switch button 12 to trigger the alarm.

Although the arrangement of the cradle 19, the lever 13, and the fastener and washer arrangement 15 achieves its intended purpose of actuating an alarm when a trip occurs, the lever 13 and fastener and washer arrangement 15 do not serve any purpose in the MCB 1 other than to engage the alarm switch 11 in order to actuate the alarm during a trip. It is well understood that additional components in a machine introduce additional sources of failure, and lead to increased complication and expense in the automated assembly process.

There is thus room for improvement in miniature circuit breakers and in trip alarm devices and systems therefor.

### SUMMARY OF THE INVENTION

These needs, and others, are met by an improved cradle for a circuit breaker. The improved cradle is structured to latch and unlatch the operating mechanism of a circuit breaker and is additionally structured to directly actuate a trip alarm without the use of additional components.

In one embodiment of the disclosed concept, a circuit breaker comprises: an operating mechanism operatively coupled to separable contacts positioned between a line terminal and a load terminal; a cradle comprising a cradle arm, the cradle being structured to latch and unlatch the operating mechanism; and an alarm switch comprising a trigger arm. The circuit breaker is structured such that when the circuit breaker is in an ON state, the separable contacts are closed and the cradle is in an ON position wherein the cradle latches the operating mechanism. The circuit breaker is structured such that when the circuit breaker is in a TRIP state, the separable contacts are open and the cradle is in a TRIP position wherein the cradle is not latching the operating mechanism. The cradle arm is structured to directly actuate the trigger arm when the cradle moves from the ON position to the TRIP position.

In another embodiment of the disclosed concept, a cradle is structured to be installed within a housing of a circuit breaker, the circuit breaker comprising an operating mechanism and an alarm switch, and the operating mechanism being operatively coupled to separable contacts positioned between a line terminal and a load terminal. The cradle comprises a cradle arm. The cradle arm is structured to directly actuate the alarm switch when the cradle moves from an ON position to a TRIP position. The ON position corresponds to the cradle latching the operating mechanism and corresponds to the separable contacts being closed. The TRIP position corresponds to the cradle not latching the operating mechanism and corresponds to the separable contacts being open.

### BRIEF DESCRIPTION OF THE DRAWINGS

A full understanding of the invention can be gained from the following description of the preferred embodiments when read in conjunction with the accompanying drawings in which:

FIG. 1A is an elevation view of a portion of a mechanism side of a prior art miniature circuit breaker (MCB) that includes a prior art cradle for latching and unlatching the operating mechanism of the MCB;

FIG. 1B is an elevation view of a portion of a printed circuit board (PCB) side of the prior art MCB of FIG. 1A, showing a lever that is rotated by the prior art cradle to actuate an alarm whenever a trip occurs in the MCB;

FIG. 2A is a perspective view of the mechanism side of an improved circuit breaker that includes an improved cradle, showing the circuit breaker in an ON state, in accordance with an exemplary embodiment of the disclosed concept;

FIG. 2B is a perspective view of the PCB side of the improved circuit breaker shown in FIG. 2A, showing the circuit breaker in the ON state, in accordance with an exemplary embodiment of the disclosed concept;

FIG. 3A is the perspective view from FIG. 2A of the mechanism side of the improved circuit breaker, showing the circuit breaker in a TRIP state, in accordance with an exemplary embodiment of the disclosed concept;

FIG. 3B is the perspective view from FIG. 2B of the PCB side of the improved circuit breaker, showing the circuit breaker in the TRIP state, in accordance with an exemplary embodiment of the disclosed concept;

FIG. 4 is an elevation view of the same portion of the interior of the circuit breaker shown in FIGS. 2B and 3B but prior to the PCB being installed, showing a support structure of the improved circuit breaker, in accordance with an exemplary embodiment of the disclosed concept;

FIG. 5A is a perspective view of the improved cradle shown in FIGS. 2A-4; and

FIG. 5B is an elevation view of the improved cradle shown in FIG. 5A.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

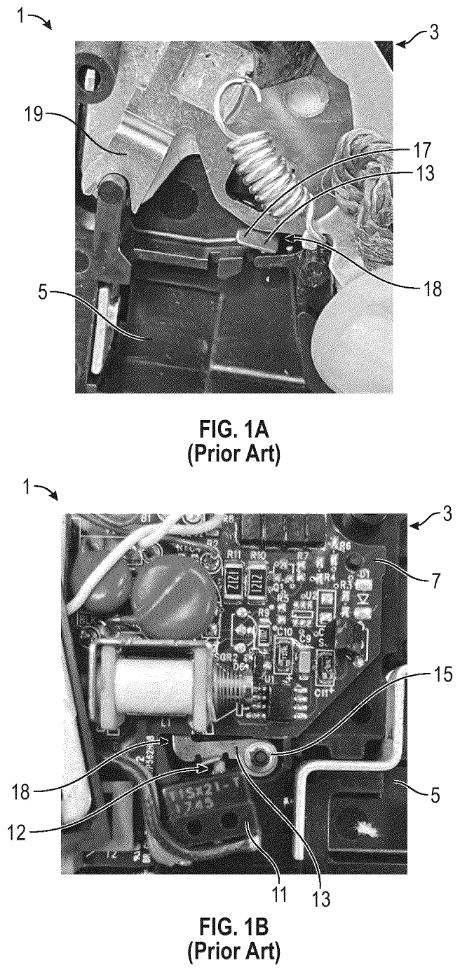

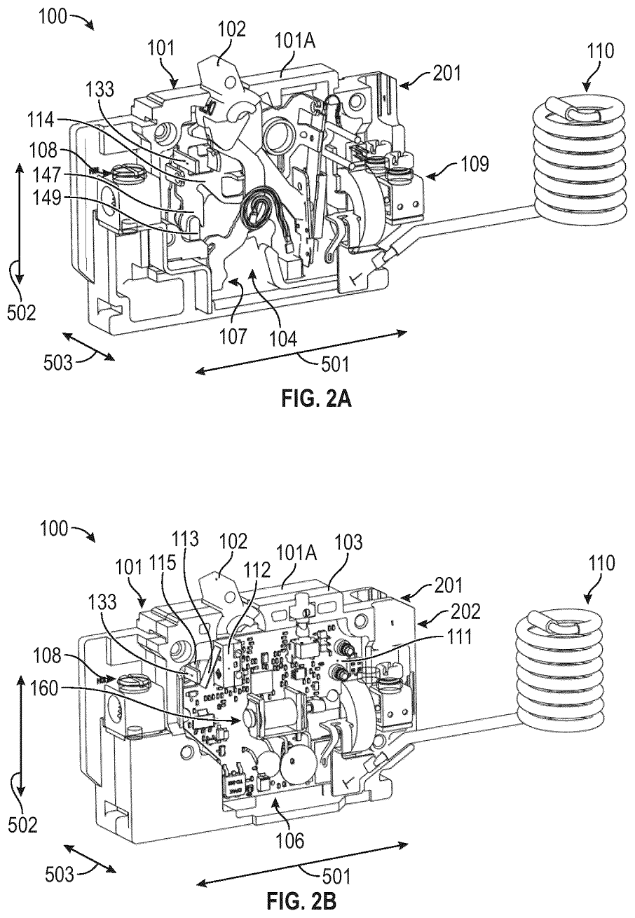

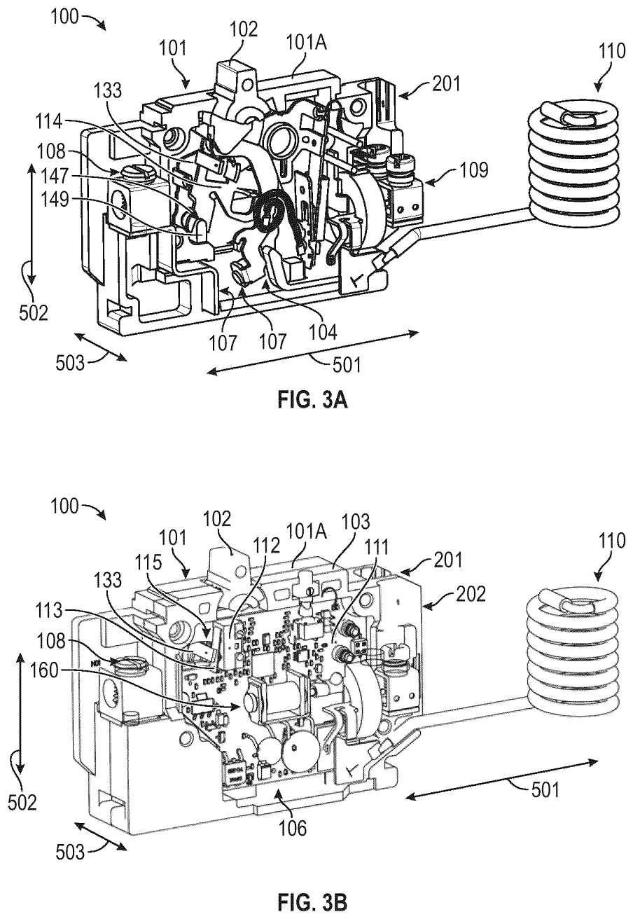

Described herein is an improved circuit breaker 100 that includes an improved cradle able to directly actuate an alarm during a trip in the circuit breaker 100, thus eliminating the need for the lever 13 and fastener and washer arrangement 15 of the prior art MCB 1 shown in FIGS. 1A-1B. The circuit breaker 100 is specifically a miniature circuit breaker (MCB) comprising a housing 101 and is shown in FIGS. 2A-3B. In each of FIGS. 2A-3B, a portion of the housing 101 is omitted so that the internal components of the circuit breaker 100 can be viewed. For clarity and ease of explanation, a length dimension 501, a width dimension 502, and a depth dimension 503 are numbered in several of the figures so that reference can be made to the dimensions of the circuit breaker 100 or any of its components and in order to provide a common frame of reference between the figures. All of the dimensions 501, 502, 503 are orthogonal to one another.

FIGS. 2A-2B show the improved circuit breaker 100 in an ON state and FIGS. 3A-3B show the improved circuit breaker 100 in a TRIP state, in accordance with an exemplary embodiment of the disclosed concept. Hereinafter, when any component of the circuit breaker 100 is described as being in the “ON position”, this denotes the position that the component is in when the circuit breaker 100 is in the ON state as shown in FIG. 2A or FIG. 2B. Similarly, when any component of the circuit breaker 100 is described as being in the “TRIP position”, this denotes the position that the component is in when the circuit breaker 100 is in the TRIP state as shown in FIG. 3A or FIG. 3B. The circuit breaker 100 includes an operating handle 102 that extends from the interior of the housing 101 to the exterior of the housing 101 in order to indicate the state of the circuit breaker 100. That is, the operating handle 102 is disposed in its ON position when the circuit breaker 100 is in the ON state (FIGS. 2A-2B) and is disposed in its TRIP position when the circuit breaker 100 is in the TRIP state (FIGS. 3A-3B).

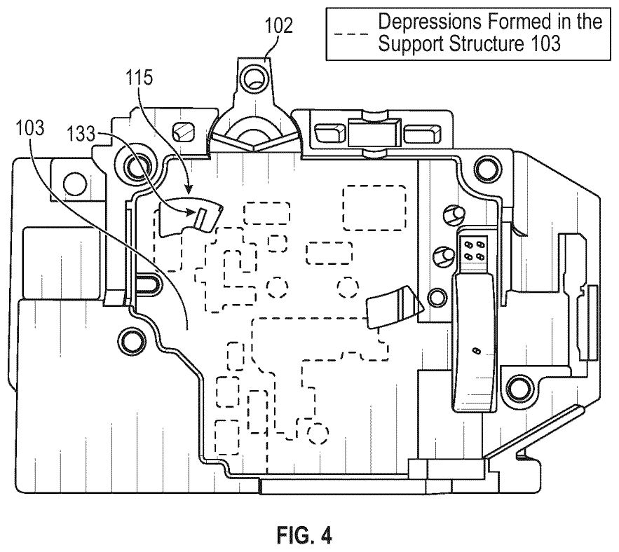

The circuit breaker 100 includes a support structure 103 (shown in FIGS. 2B and 3B) that is coupled to the housing 101 and that partitions the interior of the housing 101 into a mechanism side 201 (visible in FIGS. 2A and 3A) and a PCB side 202 (shown in FIGS. 2B and 3B). The support structure 103 is omitted from FIGS. 2A and 3A so that the mechanism side 201 can be viewed. FIG. 4 shows the circuit breaker 100 partially assembled, i.e. prior to the components of the PCB side 202 being installed, so that the support structure 103 can be seen more clearly and certain features of the support structure 103 can be more easily discerned, with said features being detailed later herein.

An operating mechanism 104 is situated on the mechanism side 201 (FIGS. 2A and 3A) and a monitoring arrangement 106 is situated on the PCB side 202 (FIGS. 2B and 3B). The operating mechanism 104 is operably coupled to a pair of separable contacts 107 that are positioned between a line terminal 108 and a load terminal 109. The circuit breaker 100 also includes a neutral conductor 110. The monitoring arrangement 106 comprises several components, including a PCB 111 that monitors the electrical conditions in the circuit breaker 100, with such electrical conditions including magnitude of current, for example and without limitation.

As previously stated, a portion of the housing 101 is omitted from FIGS. 2A-3B so that the internal components of the circuit breaker 100 can be viewed. In FIGS. 2A-3B, only a first housing portion 101A is shown, and it is noted that a second housing portion 101B is the portion of the housing 101 omitted from the figures. It is noted that, when the circuit breaker 100 is fully assembled, the second housing portion 101B is coupled to the first housing portion 101A and to the support structure 103 so that the support structure 103 is positioned between the first housing portion 101A and the second housing portion 101B. As can be seen in FIGS. 2A-3B, the mechanism side 201 is enclosed between the housing portion 101A and the support structure 103. Similarly, when the second housing portion 101B is coupled to the first housing portion 101A and to the support structure 103, the PCB side 202 is enclosed between the housing portion 101B and the support structure 103.

It should be understood that the circuit breaker 100 is in the ON state when the separable contacts 107 are in contact with one another, i.e. closed, such that current can flow through any circuits connected to the circuit breaker 100, and that the circuit breaker 100 is in the TRIP state when the separable contacts 107 are separated from one another, i.e. open, such that current is prevented from flowing through any circuits connected to the circuit breaker 100. In the ON state, there is current flow between the line terminal 108 and the load terminal 109 through the separable contacts 107. When the circuit breaker 100 is in the ON state (FIGS. 2A-2B) and the PCB 111 detects a fault condition in the circuit breaker 100, the PCB 111 initiates a trip to cause the operating mechanism 104 to open the separable contacts 107 and put the circuit breaker 100 into the TRIP state (FIGS. 3A-3B), as detailed further later herein. The operating handle 102 is coupled to the operating mechanism 104 and thus changes states as the operating mechanism 104 changes states.

The circuit breaker 100 further includes an alarm switch 112 with a trigger arm 113 on the PCB side 202 (FIGS. 2B and 3B), as well as a cradle 114 (a portion of which can be seen in FIGS. 2A and 3A) that latches and unlatches the operating mechanism 104. The trigger arm 113 is structured to be rotated between an unactuated state as shown in FIG. 2B and an actuated state as shown in FIG. 3B. When the trigger arm 113 is in its unactuated state, the alarm associated with the alarm switch 112 is unactuated. When the trigger arm 113 is in its actuated state, the alarm associated with the alarm switch 112 is actuated. It is noted that most of the cradle 114 is disposed on the mechanism side 201, except for a cradle arm 133 that extends from the mechanism side 201 to the PCB side 202 through an opening 115 in the support structure 103. The cradle arm 133 is thus positioned to actuate the alarm trigger arm 113 (see FIGS. 2B and 3B), as detailed further later herein. It is noted that the opening 115 can be most clearly seen in FIG. 4, but it is also numbered in FIGS. 2B and 3B.

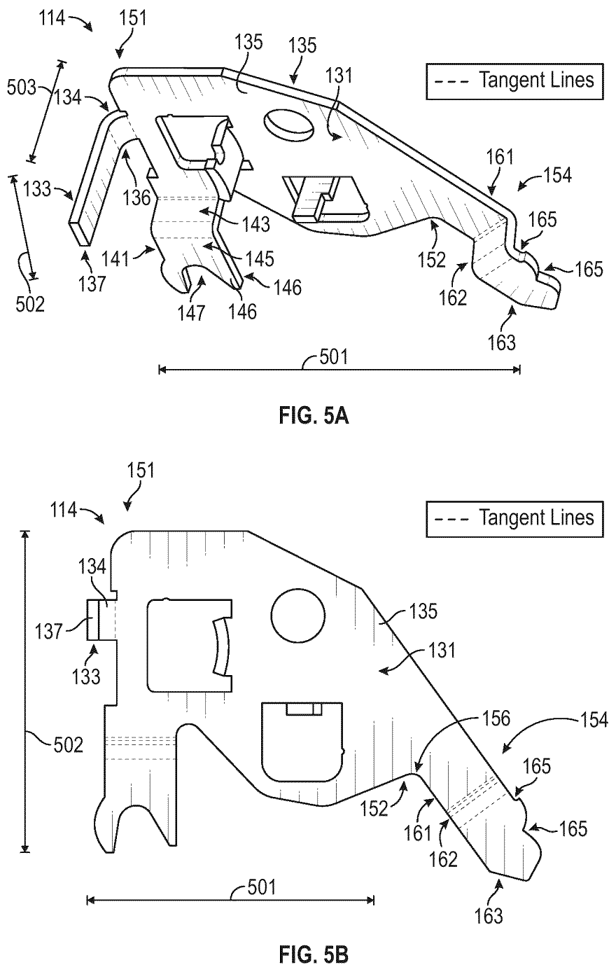

Reference is now made to FIGS. 5A-5B, which show the cradle 114 in isolation. In FIGS. 5A and 5B, tangent lines are shown in broken line, so that the curvature of various features of the cradle 114 can be discerned. The cradle 114 comprises a main body 131 and the previously mentioned cradle arm 133, which extends from the main body 131 in the depth dimension 503. The cradle 114 further comprises a joint portion 134 that joins the main body 131 and the cradle arm 133. In an exemplary embodiment as shown in the figures, the joint portion 134 is curved. The cradle arm 133 and joint portion 134 are shorter than the main body 131 relative to the width dimension 502.

The main body 131 is referred to herein as “planar” due to the majority of its surface area being planar. That is, the main body 131 comprises two major surfaces 135 that are planar and parallel to one another such that the main body 131 is of a uniform thickness relative to the depth dimension 503. When the cradle 114 is installed in the circuit breaker 100, each major surface 135 extends in the length dimension 501 and in the width dimension 502, but not in the depth dimension 503. It should be understood that only one of the major surfaces 135 can be visible at one time in the figures due to the two major surfaces 135 being parallel.

The cradle arm 133 comprises a first end 136 and a second end 137 disposed opposite the first end 136. The cradle arm 133 connects to the joint portion 134 at the first end 136 and extends from the main body 131 relative to the depth dimension 503, such that the cradle arm 133 contains at least one line extending between the first end 136 and the second end 137 that is orthogonal to the major surfaces 135 of the main body 131.

The cradle 114 further comprises a housing coupling portion 141 that extends from the main body 131. The housing coupling portion 141 has an angled section 143 that connects to the main body 131 and an inlet section 145 that connects to the angled section 143. The angled section 143 is disposed at an angle to the main body 131 such that the angled section 143 is neither co-planar nor parallel with the main body 131 (i.e. neither co-planar nor parallel with the major surfaces 135). The inlet section 145 is disposed at an angle to the angled section 143 such that the inlet section 145 is parallel to the main body 131. The angled section 143 and the inlet section 145 are shorter than the main body 131 relative to the length dimension 501.

The inlet section 145 is planar such that it comprises two major surfaces 146 that are planar and parallel to one another such that the inlet section 145 is of a uniform thickness relative to the depth dimension 503. It should be understood that only one of the major surfaces 146 can be visible at one time in the figures due to the two major surfaces 146 being parallel. The inlet section 145 is formed with an inlet 147. As shown in FIGS. 2A and 3A, a protrusion 149 extending in the depth dimension 503 is formed on the first housing portion 101A, and the inlet 147 is structured to receive the protrusion 149.

Continuing to refer to FIGS. 5A-5B, relative to the length dimension 501, the main body 131 has a first end 151 and a second end 152. It should be noted that the ends 151, 152 are referred to as “first” and “second” solely for the purpose of differentiating each from the other, and that the end 151 can instead be referred to as “second” and the end 152 can instead be referred to as “first”. The cradle arm 133 extends from the first end 151, and a latching arm 154 extends from the second end 152. In viewing FIG. 5B in conjunction with FIG. 5A, it can be seen that the latching arm 154 extends from the second end 152 in the length dimension 501, the width dimension 502, and the depth dimension 503. The cradle 114 comprises an elbow 156 (numbered only in FIG. 5B) where the main body 131 and the latching arm 154 meet.

The latching arm 154 comprises a neck section 161, a knee section 162, and a notched section 163. The neck section 161 is continuous with and coplanar with the main body 131 and is narrower than the main body 131 relative to a plane that is orthogonal to the depth dimension 503 (i.e. said plane lying only in the length and width dimensions 501, 502). The narrowing of the cradle 114 where the neck section 161 meets the main body 131 results in the formation of the elbow 156. The knee section 162 is disposed at an angle to the main body 131 and the neck section 161 such that the knee section 162 is neither co-planar nor parallel with the main body 131 (i.e. neither co-planar nor parallel with the major surfaces 135) or the neck section 161. The notched section 163 is disposed at an angle to the knee section 162 such that the notched section 163 is parallel to the main body 131 and the neck section 161. The notched section 163 is formed with a number of notches 165 structured to engage the operating mechanism 104.

Referring again to FIGS. 2A and 3A in conjunction with FIG. 5A, the cradle 114 is positioned in the housing 101 so that the main body 131 is enclosed on the mechanism side 201 of the circuit breaker 100, with the protrusion 149 (formed on the housing 101) received in the inlet 147 (formed in the cradle 114), and with the major surfaces 135 of the cradle 114 being disposed parallel to the planar surface of the PCB 111. The cradle first end 151 is positioned nearer to the line terminal 108 than the second end 152 is, and the second end 152 is positioned nearer to the load terminal 109 than the first end 151 is. As previously stated, the cradle 114 is used to latch and unlatch the operating mechanism 104. More specifically, the cradle's latching arm 154 (FIGS. 5A-5B) engages the operating mechanism 104 with the notches 165 when the circuit breaker 100 is in the ON state (FIGS. 2A-2B) in order to keep the separable contacts 107 closed when electrical conditions are within a normal range. When a fault condition is detected by the PCB 111 and the PCB 111 initiates a trip, the PCB 111 initiates action to rotate the cradle 114 such that the latching arm 154 disengages from the operating mechanism 104 and causes the operating mechanism 104 to open the separable contacts 107. In particular, the circuit breaker 100 comprises a solenoid and armature 160 (FIGS. 2B and 3B), with the armature being operatively coupled to the operating mechanism 104. When the PCB 111 determines that a fault condition exists, the PCB 111 activates the solenoid and thus activates the armature, causing movement of the armature that rotates the cradle 114 and causes the latching arm 154 to disengage from the operating mechanism 104, which causes the operating mechanism 104 to actuate opening of the separable contacts 107.

As may be most apparent from comparing FIG. 3A to FIG. 2A, the cradle 114 rotates during a trip, i.e. the position of the cradle 114 in the TRIP position as shown in FIG. 3A is rotated clockwise relative to the ON position of the cradle 114 as shown in FIG. 2A. As may be most apparent from comparing FIG. 3B to FIG. 2B, the rotation of the cradle 114 during a trip causes the cradle arm 133 to engage the alarm switch trigger arm 113, by pushing against the trigger arm 113. When the cradle arm 133 engages the alarm switch trigger arm 113, the alarm is triggered.

The disclosed improved cradle 114 represents an improvement over the prior art cradle 19, as the cradle 114 is structured to directly actuate the alarm switch 112 by engaging the trigger arm 113 with the cradle arm 133. In contrast and as previously described, the prior art cradle 19 cannot directly engage or actuate the alarm switch 11 and instead must actuate the lever 13 to engage the alarm button 12 in the prior art MCB 1. It will be appreciated that eliminating the lever 13 and the fastener and washer arrangement 15 eliminates a few sources of potential malfunction in the improved circuit breaker 100, and also shortens and simplifies the assembly process of the improved circuit breaker 100.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A circuit breaker, the circuit breaker comprising:
an operating mechanism operatively coupled to separable contacts positioned between a line terminal and a load terminal;
a cradle comprising a cradle arm, the cradle being structured to latch and unlatch the operating mechanism; and
an alarm switch comprising a trigger arm,
wherein the circuit breaker is structured such that when the circuit breaker is in an ON state, the cradle is in an ON position wherein the cradle is latching the operating mechanism and the separable contacts are closed,
wherein the circuit breaker is structured such that when the circuit breaker is in a TRIP state, the cradle is in a TRIP position wherein the cradle is not latching the operating mechanism and the separable contacts are open,
wherein the cradle arm is structured to directly actuate the trigger arm when the cradle moves from the ON position to the TRIP position.

2. The circuit breaker of claim 1, further comprising:
a monitoring arrangement, the monitoring arrangement including a PCB configured to receive data about electrical conditions in the circuit breaker,
wherein the circuit breaker is configured such that, when the circuit breaker is in the ON state and the PCB determines that a fault condition exists in the circuit breaker 100, the PCB initiates action that rotates the cradle such that the cradle unlatches the operating mechanism and causes the operating mechanism to open the separable contacts.

3. The circuit breaker of claim 2, further comprising:
a solenoid and armature, with the armature being operatively coupled to the operating mechanism,
wherein the action initiated by the PCB to rotate the cradle after the PCB determines that a fault condition exists is activation of the solenoid and armature.

4. The circuit breaker of claim 1, further comprising:
a housing; and
a support structure coupled to the housing and comprising an opening,
wherein the support structure partitions the interior of the housing into a mechanism side and a PCB side,
wherein the cradle comprises a main body from which the cradle arm extends,
wherein the operating mechanism and the main body are positioned on the mechanism side,
wherein the monitoring arrangement and the alarm switch are positioned on the PCB side, and
wherein the cradle arm extends from the mechanism side through the opening to the PCB side.

5. The circuit breaker of claim 1, further comprising:
a housing,
wherein a protrusion is formed on the housing,
wherein the cradle comprises a main body from which the cradle arm extends,
wherein the cradle comprises a housing coupling portion that extends from the main body,
wherein the housing coupling portion includes an inlet, and
wherein the protrusion is received in the inlet.

6. The circuit breaker of claim 1,
wherein the main body is planar relative to a length dimension and a width dimension,
wherein the cradle arm extends from a first end of the main body in a depth dimension, and
wherein the length dimension, the width dimension, and the depth dimension are all orthogonal to one another.

7. The circuit breaker of claim 6,
wherein the cradle further comprises a latching arm that extends from a second end (152) of the main body in the length dimension, the width dimension, and the depth dimension,
wherein the second end is disposed opposite the first end,
wherein the latching arm engages the operating mechanism when the cradle is latching the operating mechanism.

8. The circuit breaker of claim 7,
wherein the latching arm comprises a neck section, a knee section, and a notched section,
wherein the neck section is continuous with and coplanar with the main body,
wherein the knee section connects to the neck section and the notched section connects to the knee section,
wherein the knee section is disposed at an angle to the neck section such that the knee section is neither co-planar nor parallel with the neck section,
wherein notched section is disposed at an angle to the knee section such that the notched section is parallel to the neck section, and
wherein the notched section is formed with number of notches used to latch the operating mechanism.

9. The circuit breaker of claim 6, further comprising:
a housing,
wherein a protrusion is formed on the housing,
wherein the cradle comprises a housing coupling portion that extends from the main body,
wherein the housing coupling portion comprises an angled section that connects to the main body and an inlet section that connects to the angled section,
wherein the angled section is disposed at an angle to the main body such that the angled section is neither co-planar nor parallel with the main body,
wherein inlet section is disposed at an angle to the angled section such that the inlet section is parallel to the main body,
wherein the inlet section includes an inlet, and
wherein the protrusion is received in the inlet.

10. A cradle structured to be installed within a housing of a circuit breaker and to latch and unlatch an operating mechanism of the circuit breaker, the operating mechanism being operatively coupled to separable contacts positioned between a line terminal and a load terminal, and the circuit breaker comprising an alarm switch, the cradle comprising:
a main body; and
a cradle arm extending from the main body,
wherein the cradle arm is structured to directly actuate the alarm switch when the cradle moves from an ON position to a TRIP position, the ON position corresponding to the cradle latching the operating mechanism and corresponding to the separable contacts being closed, the TRIP position corresponding to the cradle not latching the operating mechanism and corresponding to the separable contacts being open.

11. The cradle of claim 10,
wherein the cradle is structured to be rotated from the ON position such that, when the cradle is rotated from the ON position, the cradle unlatches the operating mechanism and causes the operating mechanism to open the separable contacts.

12. The cradle of claim 10, further comprising:
a housing coupling portion that extends from the main body and includes an inlet, and
wherein the inlet is structured to be coupled to the housing.

13. The cradle of claim 10,
wherein the main body is planar relative to a length dimension and a width dimension,
wherein the cradle arm extends from a first end of the main body in a depth dimension, and
wherein the length dimension, the width dimension, and the depth dimension are all orthogonal to one another.

14. The cradle of claim 13,
wherein the cradle further comprises a latching arm that extends from a second end of the main body in the length dimension, the width dimension, and the depth dimension,
wherein the second end is disposed opposite the first end,
wherein the latching arm engages the operating mechanism when the cradle is latching the operating mechanism.

15. The cradle of claim 14,
wherein the latching arm comprises a neck section, a knee section, and a notched section,
wherein the neck section is continuous with and coplanar with the main body,
wherein the knee section connects to the neck section and the notched section connects to the knee section,
wherein the knee section is disposed at an angle to the neck section such that the knee section is neither co-planar nor parallel with the neck section,
wherein notched section is disposed at an angle to the knee section such that the notched section is parallel to the neck section, and
wherein the notched section is formed with a number of notches used to latch the operating mechanism.

16. The cradle of claim 13, further comprising:
wherein the cradle further comprises a housing coupling portion that extends from the main body and includes an inlet, and
wherein the inlet is structured to be coupled to the housing.
